(19) United States
(12) Patent Application Publication
(10) Pub. No.: US 2007/0192075 A1
(43) Pub. Date: Aug. 16, 2007

(54) Organism stimulation device and program

(75) Inventors: Tetsuya Matsuda, Kyoto (JP); Akira Amano, Kyoto (JP); Hidetoshi Kotera, Kyoto (JP); Kenta Hori, Kyoto (JP); Jianyin Lu, Kyoto (JP); Nobuaki Sarai, Kyoto (JP); Satoshi Matsuoka, Kyoto (JP); Akinori Noma, Kyoto (JP); Takao Shimayoshi, Kyoto (JP)

Correspondence Address: RADER FISHMAN & GRAUER PLLC, LION BUILDING, 1233 20TH STREET N.W., SUITE 501, WASHINGTON, DC, 20036, US

(73) Assignee: Kyoto University, Kyoto (JP)

(21) Appl. No.: 10/590,016

(22) PCT Filed: Feb. 14, 2005
(86) PCT No.: PCT/JP05/02138

§ 371 Date: Aug. 21, 2006

(30) Foreign Application Priority Data
Feb. 26, 2004 (JP) 20004-050607

(51) Int. Cl. G06G 7/48; G06G 7/58

(52) U.S. Cl. 703/11

(57) ABSTRACT

With conventional simulation devices, the assumption was that only cells would be simulated, and thus the simulation devices had the problem that simulations on the level of tissue, organs, or individual organisms, which are collections of cells, were not possible. The present invention is an organism simulation device that is provided with two or more different simulator parts that calculate the behavior of organism structural elements, a data output part that visually outputs simulation results, and a simulation controller that controls the transfer of data between the two or more different simulator parts and the data output part based on simulation scenario information, which is information on the flow of data and the operation sequence. With this organism simulation device, an environment in which simulation of an organism can be performed more comprehensively and with higher precision can be provided with ease.

### TECHNICAL FIELD

The present invention relates to simulation devices, programs for the same and the like, for simulating the viscera or organs, for example, of an organism.

### BACKGROUND ART

The simulation device known as E-Cell is one example of a conventional simulation device that can perform a simulation of organism functions (see Non-Patent Document 1). E-Cell could be called a so-called cell model construction framework.

[Non-Patent Document 1]

M. Tomita, K. Hashimoto, K. Takahashi, T. Shimizu, Y Matsuzaki, F. Miyoshi, K. Saito, S. Tanida, K. Yugi, J. C. Venter, and C. A. Hutchinson III, “E-CELL: software environment for whole-cell simulation” in Bioinformatics, vol. 15, no. 1, pp. 72-84, 1999

### DISCLOSURE OF INVENTION

### Problem to be Solved by the Invention

However, the simulation device of Non-Patent Document 1 assumes that only cells will be simulated, and thus has the problem that it cannot perform simulations on the level of tissue, organs, or individual organisms, in which there is a collection of cells. Further, in a case where advances in medicine lead to examination of the behavior of an organism's structural elements, that is, the elements making up an organism, such as molecules, cell organelles, cells, tissue, and organs, and simulator parts for performing a simulation of each behavior are constructed, then the device also has the problem that it cannot provide an environment in which more comprehensive, precise organism simulation can be performed.

The invention was arrived at to solve these conventional problems, and it is an object thereof to provide an organism simulation device that can easily perform simulations on the level of tissues, organs, and individual organisms, in which there is a collection of cells. A further object is to provide an environment in which new tissue, organs, or individual organisms, for example, can be simulated by adding simple data definitions (authoring). A yet further object is to easily provide an environment in which it is possible to simulate organisms more comprehensively and precisely in a case where advances in medicine lead to examination of the behavior of an organism's structural elements, that is, the elements making up an organism, such as molecules, cell organelles, cells, tissue, and organs, and simulator parts for simulating each behavior are constructed. As a result, it is an object to enable highly accurate simulations that reflect actual conditions, and by doing so facilitate future medical research and advances.

### METHODS FOR SOLVING PROBLEM

An organism simulation device according to a first aspect of the invention is an organism simulation device that is provided with two or more different simulator parts that calculate the behavior of an organism's structural elements, which are the elements making up the organism, such as molecules, cell organelles, cells, tissue, and organs, a data output part that outputs simulation results, and a simulation controller that controls the transfer of data between the two or more different simulator parts and the data output part. The two or more simulator parts include an input data reception unit for receiving data from a user and/or the simulation controller, a calculation unit for performing predetermined calculations on the data received by the input data reception unit to create output data, and an output data output unit for transferring the output data to the simulation controller. The data output part includes an output data reception unit for receiving output data from the simulation controller, and an output unit for outputting the output data received by the output data reception unit. The simulation controller includes a simulation scenario information storage unit storing simulation scenario information, which is information on the flow of data between the two or more simulator parts and the data output part, and the operation sequence, a data reception unit for receiving data from the two or more simulator parts, an input data transfer unit for transferring the data received by the data reception unit to the simulator parts based on the simulation scenario information, and an output data transfer unit for transferring the data that have been received from the two or more simulator parts to the data output part based on the simulation scenario information.

With this configuration, it is easy to perform a simulation on a tissue, organ, or individual organism level, in which there is a collection of cells. It is also possible to easily provide an environment in which simulation of an organism can be performed more comprehensively and with higher precision. For example, looking at the heart as a whole, the excitation that occurs in the sinoatrial node is transmitted to the entire heart through the heart's conducting system. This process is one type of electrical phenomenon and can be simulated by electric field analysis, for example. The entire heart contracts due to the contraction force that is generated by the cells, and this is a mechanical phenomenon that can be calculated using a finite element method, for example. Further, the contraction of the heart increases pressure within the heart and leads to the ejection of blood. This can be understood as a hydrodynamic phenomenon. Many other phenomena are related to a heartbeat, including the oxygen concentration gradient in cardiac muscle due to the coronary arteries. There also is interaction between the cells and the organ. For example, mechanical stress on the myocardial cells due to mechanical deformation of the heart affects the electrophysiological phenomena of the cells through excitation-contraction coupling. Thus, it is necessary to take into account numerous phenomena and the interactions between these phenomena when looking at even a single heartbeat. Further, many different phenomena and interactions between these phenomena are related to different organism functions, such as drug absorption at the small intestine. These phenomena take on various forms, such as those common among a plurality of organism functions, those that can be calculated by the same method, and those that are unique to a particular organism function. With this embodiment, it is possible to provide a generalized simulation platform for organism functions by combining the above simulator parts, which can perform simulations individually.

An organism simulation device according to a second aspect of the invention is the organism simulation device of the first aspect of the invention, in which the data output part further includes an input data obtaining unit for obtaining input data to be input to the simulator parts, the output unit saves the output data received by the output data reception unit and the input data obtained by the input data obtaining unit as a pair, and the organism simulation device further includes an output data reception portion that receives an input of output data, an input data retrieve portion that retrieves input data that pair with the output data that are received by the output data reception portion, or with output data that approximate the output data that are received by the output data reception portion, and an input data output portion that outputs the input data that have been retrieved by the input data retrieve portion.

This configuration allows conditions to be deduced from the results and thus can be adopted to analyze the cause of disease states or to search for drug discovery targets, and for example allows a patient's condition to be known in a manner in which surgery or tests that place a heavy stress on the patient can be avoided.

### EFFECTS OF THE INVENTION

The invention allows various organism functions to be simulated combining simulator parts that correspond to functional elements that constitute an organism function, such as individual organisms, viscera/organs, cells/tissue, cell organelles, and molecules.

### BEST MODE FOR CARRYING OUT THE INVENTION

Embodiments of the organism simulation device, etc. are described below in reference to the drawings. It should be noted that in the embodiments, structural elements that have been assigned identical reference numerals perform similar operations, and repeated description thereof may be omitted.

### Embodiment 1

This embodiment describes an organism simulation device, etc. that can perform complicated organism simulations using at least two organism element simulator parts. The organism simulation device is provided with at least two different organism element simulator parts, a data output part, and a simulation controller. The two organism element simulator parts are simulator parts that receive input and output a simulation result. The data output part is for visualizing the results of the simulation. The simulation controller converts the output of a simulator part into the input of another simulator part and transfers the converted data to the other simulator part, and also transfers the output of the simulator parts to the data output part as is or after converting the output.

That is, the simulator parts simulate the microscale behavior of each organism structural element, that is, the elements making up the organism, such as molecules, cell organelles, cells, tissue, and organs. The simulation controller allows behavior on a microscale level, that is, the interactions between organism structural elements, to be simulated. The data output part allows the interactions between the organism's structural elements and the external environment to be simulated.

The organism simulation device according to this embodiment of the invention is described below using the drawings. FIG. 1 is a block diagram of the organism simulation device of the embodiment. The organism simulation device is provided with at least two different simulator parts (101(1), 101(2), . . . 101(n)), a data output part 102, a simulation controller 103, a simulation scenario information input reception portion 104, and a simulation scenario information save portion 105. The simulator parts may be collectively referred to by the reference numeral 101.

The simulator parts 101 are provided with an input data reception unit 1011, a computation unit 1012, and an output data output unit 1013.

The data output part 102 is provided with an output data reception unit 1021 and an output unit 1022.

The simulation controller 103 is provided with a simulation scenario information storage unit 1031, a data reception unit 1032, an input data transfer unit 1033, an output data transfer unit 1034, an input reception unit 1035, and an information save unit 1036.

The input data reception unit 1011 receives data from the user and/or the simulation controller 103. Data are received from the user through a graphical user interface (GUI), for example. The input unit in this case can be any one of a number pad, keyboard, mouse, or menu-screen, etc. through which input is made. With respect to the reception of data from the simulation controller 103, examples include receipt of a message (if equipped by object-oriented programming), transfer by function arguments, and the reception of data. If the data are received, then the simulation controller 103 and the simulator parts 101 are provided in different devices. The input data reception unit 1011 can be achieved by the device driver of the input unit such as a number pad or a keyboard, or through the control software for a menu screen, for example.

The computation unit 1012 performs predetermined computations on the data received by the input data reception unit 1011 to create output data. That is, the computation unit 1012 is the core element for calculating the behavior of the organism's structural elements, that is, the elements making up an organism, such as molecules, cell organelles, cells, tissue, and organs. The computation unit 1012 ordinarily can be achieved by an MPU or a memory, for example. The processing procedure of the computation unit 1012 ordinarily is achieved by software, and that software is recorded on recording media such as a ROM. However, it is also possible for the computation unit 1012 to be achieved by hardware (dedicated circuit).

The output data output unit 1013 transfers the output data that are produced by the computation unit 1012 to the simulation controller 103. Examples of the method for sending the output data to the simulation controller 103 include transmitting a message (if equipped by object-oriented programming), transfer by function arguments, and the transmission of data. The output data output unit 1013 ordinarily can be achieved by an MPU or a memory, for example. The processing procedure of the output data output unit 1013 ordinarily is achieved by software, and that software is recorded on recording media such as a ROM. However, it is also possible for the output data output unit 1013 to be achieved by hardware (dedicated circuit). It should be noted that if the method for transferring output data to the simulation controller 103 is the transmission of data, then the output data output unit 1013 ordinarily can be achieved by a wireless or wired communication unit or broadcasting unit. If the output data are sent to the simulation controller 103 by way of data transmission, then the simulation controller 103 and the simulator parts 101 are provided in different devices.

The output data reception unit 1021 receives output data from the simulation controller 103. The methods by which it receives output data includes methods by issuing an event, transfer by function arguments, and the reception of data. The output data reception unit 1021 ordinarily can be achieved by an MPU or a memory, for example. The processing procedure of the output data reception unit 1021 ordinarily is achieved by software, and that software is recorded on recording media such as a ROM. However, it is also possible for the output data reception unit 1021 to be achieved by hardware (dedicated circuit). If the methods for receiving output data is achieved by the reception of data, then the simulation controller 103 and the data output part 102 are provided in different devices.

The output unit 1022 is for outputting the output data received by the output data reception unit 1021. Here, the concept of outputting is inclusive of displaying on a display, printing on a printer, sound output, saving on a recording medium, and transmitting to an external device, for example. The output unit 1022 can for example be achieved by a display and the driver software for that display.

The simulation scenario information storage unit 1031 stores simulation scenario information, which is information on the flow of data between the at least two simulator parts 101 and the data output part 102, and the operation sequence controlling the operations of the at least two simulator parts 101 and the data output part 102. The simulation scenario information storage unit 1031 is ideally a nonvolatile recording medium, but it also can be achieved by a volatile recording medium.

The data reception unit 1032 is for receiving data from the two or more simulator parts 101. The data reception unit 1032 also receives information (data) that has been saved by the information save unit 1036. The data that are received by the data reception unit 1032 are the data of the results of the simulation by the simulator parts 101 or data that have been input. The methods through which the data reception unit 1032 receives data includes, as mentioned above, via messages or issuing an event, transfer by function arguments, and the reception of data. The data reception unit 1032 ordinarily can be achieved by an MPU or a memory, for example. The processing procedure of the data reception unit 1032 ordinarily is achieved by software, and that software is recorded on a recording medium such as a ROM. However, it is also possible for the data reception unit 1032 to be achieved by hardware (dedicated circuit).

The input data transfer unit 1033 transfers the data that have been received by the data reception unit 1032 to the simulator parts 101 based on the simulation scenario information stored in the simulation scenario information storage unit 1031. The input data transfer unit 1033 can transfer the data that it receives from one simulator part to another simulator part as is, or process the data in some manner and then transfer those processed data to another simulator part. The input data transfer unit 1033 ordinarily can be achieved by an MPU or a memory, for example. The processing procedure of the input data transfer unit 1033 ordinarily is achieved by software, and that software is recorded on a recording medium such as a ROM. However, it is also possible for the input data transfer unit 1033 to be achieved by hardware (dedicated circuit).

The output data transfer unit 1034 transfers the data that have been received from the at least two simulator parts 101 to the data output part 102 based on the simulation scenario information stored in the simulation scenario information storage unit 1031. The methods by which the output data transfer unit 1034 transfers data includes, as mentioned above, through messages or issuing an event, transfer by function arguments, and the reception of data. The output data transfer unit 1034 ordinarily can be achieved by an MPU or a memory, for example. The processing procedure of the output data transfer unit 1034 ordinarily is achieved by software, and that software is recorded on a recording medium such as a ROM. However, it is also possible for the output data transfer unit 1034 to be achieved by hardware (dedicated circuit).

The input reception unit 1035 urges the user to input information, and receives the information that is input, based on the simulation scenario information stored in the simulation scenario information storage unit 1031. This information is used in the simulation. The input reception unit 1035 can be achieved by software, for example, that outputs GUI screen defined information, which is input, and a screen from the GUI screen defined information, and through this receives input.

The information save unit 1036 temporarily saves the information received by the input reception unit 1035. That information is saved on a predetermined recording medium (ordinarily, a volatile recording medium). The information save unit 1036 ordinarily can be achieved by an MPU or a memory, for example. The processing procedure by which the information save unit 1036 saves information ordinarily is achieved by software, and that software is recorded on a recording medium such as a ROM. However, it is also possible for the information save unit 1036 to be achieved by hardware (dedicated circuit).

The simulation scenario information input reception portion 104 receives the input of simulation scenario information. The simulation scenario information input reception portion 104 receives the new input of simulation scenario information, and the input of corrections for customizing the simulation scenario information. The unit by which the simulation scenario information is input can be any of a number pad, a keyboard, a mouse, or a menu screen, for example. The simulation scenario information input reception portion 104 can for example be achieved by the device driver for the input unit such as a number pad or a keyboard, or by the control software of a menu screen.

The simulation scenario information save portion 105 saves the simulation scenario information that is received by the simulation scenario information input reception portion 104 on the simulation scenario information storage unit 1031. The simulation scenario information save portion 105 ordinarily can be achieved by an MPU or a memory, for example. The processing procedure by which the simulation scenario information save portion 105 saves information ordinarily is achieved by software, and that software is recorded on a recording medium such as a ROM. However, it is also possible for the information save unit 1036 to be achieved by hardware (dedicated circuit).

Next, the operation of this organism simulation device is described using the flowchart in FIG. 2. It should be noted that in the flowchart of FIG. 2, the simulation scenario information is already stored on the simulation scenario information storage unit 1031. That is, the processing of the simulation scenario information input reception portion 104 and the simulation scenario information save portion 105 for receiving and customizing the simulation scenario information is not described here. Here, also, the input of data from the user to the simulator parts (101(1), 101(2), . . . 101(n)) is complete, and the simulator parts (101(1), 101(2), . . . 101(n)) already hold those data. However, it is not essential that the data have been input from the user to the simulator parts (101(1), 101(2), . . . 101(n)). There also may be simulator parts for which the input of data from the user is not necessary.

(Step S201) The simulation controller 103 reads the simulation scenario information stored on the simulation scenario information storage unit 1031.

(Step S202) A 1 is assigned to the counter i.

(Step S203) The input reception unit 1035 determines whether or not the information of the i-th row (i-th information) of the simulation scenario information is a data input command that orders the input of data. If it is a data input command, then the procedure is advanced to step S204, and if it is not a data input command, then the procedure jumps to step S208.

(S204) The input reception unit 1035 creates an input screen that urges the user to input data, based on the information of the i-th row of the simulation scenario information, and displays this input screen. The information for creating the input screen (which for example is described in a program language such as HTML or JAVA©) has been saved in advance. The technology of creating and displaying an input screen is technology in the public realm, and thus will not be described in detail.

(Step S205) The input reception unit 1035 determines whether or not data have been received from the user. If data have been received, then the procedure advances to step S206, and if data have not been received, then the procedure returns to step S205.

(Step S206) The information save unit 1036 temporarily saves the data received in step S205.

(Step S207) The counter i is increased by an increment. The procedure returns to step S203.

(Step S208) The input reception unit 1035 determines whether or not the information of the i-th row (i-th information) of the simulation scenario information is an input data transfer command that orders data to be transferred to the simulator part 101. If it is an input data transfer command, then the procedure advances to step S209, and if it is not an input data transfer command, then the procedure jumps to step S213.

(Step S209) The input data transfer unit 1033 creates input data to transfer to the simulator part 101 based on the information of the i-th row of the simulation scenario information.

(Step S210) The input data transfer unit 1033 transfers the input data that it has created in step S209 to the simulator part 101 specified by the information of the i-th row.

(Step S211) The input data reception unit 1011 of the simulator part 101 receives data.

(Step S212) The input data reception unit 1011 of the simulator part 101 temporarily saves the data that are received in step S211. The procedure moves to step S207.

(Step S213) The output data transfer unit 1034 determines whether or not the information of the i-th row (i-th information) of the simulation scenario information is an output data transfer command, which is a command for receiving data from the simulator part 101. If it is an output data transfer command, then the procedure advances to step S214, and if it is not an output data transfer command, then the procedure jumps to step S218.

(Step S214) The output data transfer unit 1034 requests the data (output data of the simulator part 101), that is, the result of the simulation, from the simulator part 101 indicated by the information of the i-th row of the simulation scenario information.

(Step S215) The computation unit 1012 of the simulator part 101 performs computations based on the request made in step S214. That computation is performed using the data that have been stored temporarily and/or the data included in the request of step S214.

(Step S216) The output data output unit 1013 outputs the data of the result of the computation in step S215 to the simulation controller 103.

(Step S217) The data reception unit 1032 of the simulation controller 103 obtains and temporarily saves the data that are output in step S216. The procedure moves to step S207.

(Step S218) The output data transfer unit 1034 determines whether or not the information of the i-th row (i-th information) of the simulation scenario information is an output command for transferring the data to the data output part 102 and outputting the data. If it is an output command, then the procedure advances to step S219, and if it is not an output command, then the procedure moves to step S207.

(Step S219) The output data transfer unit 1034 creates output data based on the information of the i-th row of the simulation scenario information.

(Step S220) The output data transfer unit 1034 sends the output data that it has created in step S219 to the data output part 102.

(Step S221) The output data reception unit 1021 receives the output data. Then, the output unit 1022 outputs those output data. If that output is a display, then the output is simulated.

It should be noted that FIG. 2 details the procedure executed by each of the simulator part 101, the data output part 102, and the simulation controller 103, but ordinarily the simulator part 101, the data output part 102, and the simulation controller 103 operate in an integrated manner while executing their operations independently by sending and receiving messages, for example. In this case, the simulation controller 103 has the function of controlling all of the operations.

FIG. 3 is a flowchart showing only the operation of the simulation controller 103. Compared to the flowchart of FIG. 2, it is missing step S211, step S212, step S215, step S216, step S217, and step S221. Step S211, step S212, step S215, and step S216 are operations of the simulator part 101, and step S221 is an operation of the data output part. To the flowchart of FIG. 3 have been added step S301 and step S302. Step S301 and step S302 are more detailed versions of the operation of step S217. Step S301 and step S302 are described in detail below.

(Step S301) The output data transfer unit 1034 determines whether or not data have been obtained from the simulator part 101. If data have been obtained, then the procedure advances to step S302, and if data have not been obtained, then the procedure returns to step S301.

(Step S302) The output data transfer unit 1034 temporarily saves the data that are obtained in step S301. The procedure moves to step S207.

Next, the specific operation of the organism simulation device of this embodiment is described. The simulation scenario information shown in FIG. 4 has already been stored on the simulation scenario information storage unit 1031.

First, the simulation scenario information of FIG. 4 is described. The simulation scenario information of FIG. 4 is constituted by 15 rows of information. The information of rows other than the 8^{th}, 14^{th} and 15^{th} rows contains send-receive destination information showing where the information is to be sent and received, and command information indicating a command. The send/receive destination information is the information bracketed by brackets “[”, “]”. The send/receive destination information “[GUI->SimulationController]” indicates that the information that has been input by the user is transferred to the simulation controller 103. That is, in FIG. 4 the “SimulationController” is the simulation controller 103.

Also, “[SimulationController->CellSimulator]” indicates that the data or command is sent from the simulation controller 103 to the simulator part 101 known as the “CellSimulator” for performing a simulation of the cell.

Next, the specific operation of the organism simulation device using the simulation scenario information of FIG. 4 is described. Here, there are two simulator parts 101. One of the simulator parts 101 is a simulator part that simulates a single myocardial cell (hereinafter appropriately referred to as “cell simulator”). The other simulator part 101 is a simulator part that calculates the deformation of the organ (hereinafter appropriately referred to as “finite element module”). In this example, simulation of a myocardial cell is performed. The simulator part that calculates the deformation of the organ uses a finite element method.

First, the simulation controller 103 reads the information of the first row of the simulation scenario information of FIG. 4. The information of the first row is “[GUI->SimulationController]setMeshData (3DMeshData).” “setMeshData (3DMeshData)” is a data input command for allowing 3D mesh data to be input. Due to this command, the input reception unit 1035 creates and displays a GUI screen for inputting 3D mesh data. Next, the input reception unit 1035 receives input from the user on his/her selection for the 3D mesh data, and sets this. Ordinarily, a plurality of 3D mesh data are stored, and the user selects one 3D mesh data from among those plurality of 3D mesh data. Ordinarily, a single 3D mesh data is a single file, and the user makes his selection from among a plurality of files. Here, setting is the process of temporarily storing the 3D mesh data to a predetermined recording region. It should be noted that it is of course also possible for the user to input 3D mesh data himself and for this to be received by the input reception unit 1035.

Next, the simulation controller 103 reads the information of the second row of the simulation scenario information of FIG. 4. The information of the second row is “[GUI->SimulationController]setMaterialProperty(youngRatio).” “setMaterialProperty(youngRatio)” is a data input command that allows the material constant (Young's modulus) to be input. The material constant (Young's modulus) is data that are set for the 3D mesh data. Due to this command, the input reception unit 1035 creates and displays a GUI screen for allowing the material constant (Young's modulus) to be input. Next, the input reception unit 1035 receives input from the user on the material constant (Young's modulus) and sets this for the 3D mesh data.

Next, the simulation controller 103 reads the information of the third row of the simulation scenario information of FIG. 4. The third row of information is “[GUI->SimulationController]setBoundaryCondition(staticWaterPressure).” “setBoundaryCondition(staticWaterPressure)” is a data input command for allowing the static water pressure to be input. The static water pressure is data that are set for the inner wall as the boundary condition in the 3D mesh data. Due to this command, the input reception unit 1035 creates and displays a GUI screen that allows the static water pressure to be input. Next, the input reception unit 1035 receives input from the user on the static water pressure and sets this for the inner wall as the boundary conditions in the 3D mesh data. It should be noted that in the case of a heart, blood that flows through the heart affects the behavior of the cells. The blood pressure data (static water pressure) is one type of input data of the system.

Next, the simulation controller 103 reads the information of the fourth row of the simulation scenario information of FIG. 4. The fourth row of information is “[GUI->SimulationController]setCellDirection(surfaceElements).” “setCellDirection(surfaceElements)” is a command for setting the cell orientation data. By the simulation controller 103 receiving this command, the simulation controller 103 creates cell orientation data from the 3D mesh data and the inner wall and outer wall element data. The inner wall and outer wall element data constitute a list of the element numbers of the elements making up the inner wall and the outer wall, for example. The cell orientation data for example has information on the element numbers and the xyz direction vectors (x1, Y1, z1) of the 3D mesh data. Each element number of the 3D mesh data is information that specifies an element when the 3D mesh data are partitioned into a plurality of elements. It should be noted that the direction in which a cell contracts differs depending on the arrangement of that cell in space. Thus, the behavior of the heart overall will also be different. The direction in which the cell is arranged in space is expressed by the cell orientation data.

Next, the simulation controller 103 reads the information of the fifth row of the simulation scenario information of FIG. 4. The fifth row of information is “[GUI->SimulationController]setCellModels(cellModels).” “setCellModels(cellModels)” is a data input command for allowing the cell model data to be input. The cell model data are data corresponding to the elements of the 3D mesh data. Due to this command, the input reception unit 1035 creates and displays a GUI screen for allowing the cell model data to be input. Next, the input reception unit 1035 receives the input of cell model data from the user and sets this input as the cell model data corresponding to the elements of the 3D mesh data. The cell model data are data on the biological behavior of a single cell plotted on a time axis. For example, the cell model data are data on the change in cell membrane potential or ion channel concentration, data on the change in metabolites such as ADP•ATP, and data on the change in proteins relating to genes. The cell model data can be described in XML format, for example, but there are no restrictions regarding the data structure.

Next, the simulation controller 103 reads the information of the sixth row of the simulation scenario information of FIG. 4. The sixth row of information is “[SimulationController->CellSimulator]setCellModels(cellModels).” “setCellModels(cell odels)” is an input data transfer command for setting the cell model data in the cell simulator. Due to this input data transfer command, the input data transfer unit 1033 transfers the cell model data to the simulator part 101 that serves as the cell simulator. The simulator part 101 that serves as the cell simulator receives and sets the cell model data. In FIG. 4, “CellSimulator” indicates the simulator part 101 that serves as the cell simulator.

Next, the simulation controller 103 reads the information of the seventh row of the simulation scenario information of FIG. 4. The seventh row of information is “[SimulationController->CellSimulator]getCellReductionForce (dt,length).” “getCellReductionForce(dt,length)” is an output data transfer command for calculating the cell contraction force after a time dt with respect to the sarcomere length for each cell with the cell simulator, and obtaining the resulting data. This command is sent from the simulation controller 103 to the cell simulator. The cell simulator then calculates the cell contraction force after a time dt with respect to the sarcomere length for each cell, and sends the resulting data to the simulation controller 103. The resulting data are cell contraction force data. The cell contraction force data are the chronological data on the contraction force of the cell. The cell contraction force data are data having a plurality of force values (unit: micro-Newton). For example, the cell contraction force data are data having a plurality of combinations of a time and a force value.

Next, the simulation controller 103 reads the information of the eighth row of the simulation scenario information of FIG. 4. The simulation controller 103 then repeats the processing indicated by the information of the seventh row until the calculations for one cycle are finished. The results are saved as cell contraction force data. It should be noted that the cell contraction force data include an element number, information indicating the time, and information indicating the contraction force. The cell contraction force data are calculated from the cell simulator, analyzed by the finite element module, and cause a beat in the heart overall. It should be noted that one cycle means the period corresponding to one heartbeat. The cells generate a contraction force in cyclical manner in correspondence with the heartbeat.

Next, the simulation controller 103 reads the information of the ninth row of the simulation scenario information of FIG. 4. The ninth row of information is “[SimulationController->FEMSimulator]setSimulationData(SimulationData).” “setSimulationData(SimulationData)” is an input data transfer command that orders the simulation data to be sent and set. This command is made from the simulation controller 103 to the finite element module. Due to this input data transfer command, the simulation data are sent to the finite element module, and the finite element module receives and temporarily saves the data. The simulation data here include the 3D mesh data, data indicating the material properties, and data indicating the boundary condition. In order to construct a model of tissue or an organ from a biological behavior model of a single cell, the cell is arranged spatially, and based on its dynamic interactions (finite element analysis method), the behavior of the entire tissue or organ is simulated. At this time, the spatial arrangement information of that cell is the 3D mesh data. In the case of the heart, a model shaped like an oval is used. The material property data are data that express the dynamic characteristics of the cell. Further, since cells in tissue or organ walls often exhibit different behavior than cells within tissue, in finite element analysis the data for specifying this (discriminate between a cell within the tissue and a cell in the tissue wall) are the boundary condition data. It should be noted that the simulation data are for example in MFD format, but the data format is not important. The MFD format is frequently used as the input file format of finite element modules. In FIG. 4, the “FEMSimulator” indicates the finite element module (one of the simulator parts).

Next, the simulation controller 103 reads the information of the tenth row of the simulation scenario information of FIG. 4. The tenth row of information is “[SimulationController->FEM Simulator]setCellDirection( ).” “setCellDirection( )” is an input data transfer command that orders the cell orientation data to be transferred. Due to this command, the cell orientation data are sent to the finite element module. That simulator part 101 receives and sets the cell orientation data.

Next, the simulation controller 103 reads the information of the eleventh row of the simulation scenario information of FIG. 4. The eleventh row of information is “[SimulationController->FEMSimulator]setCellReductionForce(CellReductionForce).” “setCelReductionForce(CellReductionForce)” is an input data transfer command that orders the cell contraction force data to be set in the finite element module. Due to this command, the cell contraction force data are sent from the simulation controller 103 to the finite element module, and the finite element module sets the cell contraction force data.

Next, the simulation controller 103 reads the information of the twelfth row of the simulation scenario information of FIG. 4. The twelfth row of information is “[SimulationController->FEMSimulator]getOrganDeformation(dt).” “getOrganDeformation(dt)” is an output data transfer command that orders the finite element module to calculate the organ deformation after a time dt and then send the results of that calculation. Due to this command, the finite element module calculates the organ deformation after the time dt and sends the result of that calculation to the simulation controller 103.

Next, the simulation controller 103 reads the information of the thirteenth row of the simulation scenario information of FIG. 4. The thirteenth row of information is “[SimulationController->Visualizer]setOrganDeformation(OrganDeformation).” It should be noted that “Visualizer” indicates the data output part 102.

“setOrganDeformation(OrganDeformation)” is an output command for transferring the data of the calculation result by the finite element module regarding the organ deformation to the data output part 102 and then visualizing those data. Due to this command, the simulation result data of the finite element module are sent to the data output part 102. Next, the data output part 102 receives those data and visually outputs them. Due to this output, the deformation of the organ is visually displayed in a graphical manner. FIG. 5 shows an example of this display. FIG. 5 shows a simulation of the motion of the heart. It should be noted that the simulation result data are data in the t19/t16 format, for example. Also, the simulation result data include information on the 3D shape, displacement, stress tensor, strain tensor, velocity, and acceleration, for example. 3D shape is shape information on the 3D shape of the heart and the 3D mesh that is input. The shape information is for example a group of information (x,y,z) of the points making up the shape of the heart. The displacement is data on the spatial displacement of the elements of the heart 3D mesh, and it is from this information that the motion during a heartbeat is understood. The stress tensor is data on the force that acts on the elements, and is output from the finite element module. The strain tensor is data on the strain that acts on the elements, and is output from the finite element module. The velocity is the velocity of the spatial motion of the elements of the heart 3D mesh. The acceleration is the acceleration of the spatial motion of the elements of the heart 3D mesh.

Next, the simulation controller 103 reads the information of the fourteenth row of the simulation scenario information of FIG. 4. The simulation controller 103 then repeats the processes indicated by the information of rows twelve and thirteen until the calculations for one cycle are finished. Thus a simulation of the deformation of the organ is executed.

Next, the simulation controller 103 reads the information of the fifteenth row of the simulation scenario information of FIG. 4. The procedure is then returned to the information of the first row of the simulation scenario information. The above processing is repeated. It should be noted that the above processing is ended by turning off the power or by interrupting the process with a process end command.

It should be noted that the cell simulator, is for example, achieved by a cell simulator that calculates a single myocardial cell model. The finite element module can be achieved by a finite element method solver (for example, the commercial software (Marc)) that calculates the mechanical deformation. The data output part 102 can be achieved by a commercial visualization tool kit (AVS). That is, the above organism simulation device operates as follows based on the simulation scenario information. First, the selected myocardial cell model is simulated by the cell simulator. Next, the simulation controller 103 obtains data on the contraction force over time, that is, the results of that simulation. Next, the data on the contraction force over time, the selected cell arrangement model and the shape data are transferred to the finite element module, and the finite element model is activated. The finite element model then outputs data on the change in shape over time. Next, the simulation controller 103 obtains the data on the change in shape over time and transfers the data to the data output part 102. The data output part 102 performs a simulation of the heartbeat based on the data of the shape change over time. This simulation is displayed as a three-dimensional animation, for example.

Thus, with this embodiment, it is possible to simulate various organism functions by combining simulator parts corresponding to functional elements that constitute organism functions, such as individual organisms, viscera/organs, cells/tissue, cell organelles, and molecules. Various research is being conducted in the field of medicine, and in many cases the aim is to uncover the functional elements that constitute an organism function. One can say this due to the degree of difficulty of the research. Also, for example, the behavior of various components such as cells influences other behaviors and determines the behavior of the individual organism or organ. The organism simulation device of this embodiment takes into account the characteristics of the medical field, and makes it possible to achieve highly precise simulation in which the simulator parts for simulating the various organism components (e.g. myocardial cells) are structurally separated from the region (simulation controller) that controls the organism components, and in which the incorporation of new simulator parts does not affect other parts. That is, with this embodiment, it is easy to combine simulator parts being scrutinized to permit precise organism simulation that reflects the current state of medicine, and thus facilitates future research and advances in medicine. It is also very easy to expand the simulation functions in conjunction with medical advances. Here, functional element is used to refer to the electrophysiological behavior of myocardial cells mentioned above, the behavior of the metabolic aspects of the cell, or the change in shape of the organ. That is, the simulator parts can be achieved by software that simulates the electrophysiological behavior of myocardial cells, software that simulates the shape of an organ, or software that simulates the metabolic behavior of the cell. The same applies to the other embodiments as well.

For example, looking at the heart as a whole, the excitation that occurs in the sinoatrial node is transmitted to the entire heart through the heart's conducting system. This process is a form of electrical phenomena and can be simulated through electric field analysis, for example. The entire heart contracts due to the contraction force that is generated by the cells, and this is a mechanical phenomenon that can be calculated using a finite element method, for example. Further, the pressure within the heart rises due to contraction of the heart and leads to the ejection of blood. This can be understood as a hydrodynamic phenomenon. Many other phenomena are related to a heartbeat, including the oxygen concentration gradient in cardiac muscle produced by the coronary arteries. There also is interaction between the cells and the organ. For example, mechanical stress on the myocardial cells due to mechanical deformation of the heart affects the electrophysiological phenomena of the cells through excitation-contraction coupling. Thus, it is necessary to take into account numerous phenomena and the interactions between these phenomena when looking at even a single heartbeat. Further, many different phenomena and the interactions between those phenomena are related to different organism functions, such as drug absorption at the small intestine. These phenomena take on various forms, such as those common to a plurality of organism functions, those that can be calculated by the same method, and those that are unique to a particular organism function. With this embodiment, it is possible to provide a generalized simulation platform for organism functions. The same applies in the other embodiments as well.

Also, as discussed above, organism functions and the functional elements of the organism function are not yet fully understood. It is anticipated that these will come to be understood in the future through medical research. The structure of the organism simulation device of this embodiment is a favorable structure for a case in which more detailed, precise simulation is to be performed by incorporating simulator parts that have been constructed according to the organism functions or functional elements that will likely come to be understood over time. In other words, it is provided with a structure that is very well suited for simulation of an organism, in that it allows simulation functions to be expanded very easily in response to medical advances. The same applies in the other embodiments as well.

It should be noted that this embodiment did not sufficiently describe a configuration for customizing the simulation scenario information, but it is of course also possible for the simulation scenario information to be customizable. In this case, in addition to the configuration of the above organism simulation device, the organism simulation device is further provided with a simulation scenario information input reception portion for receiving the input of the simulation scenario information, and a simulation scenario information save portion for saving the simulation scenario information that is received by the simulation scenario information input reception portion on the simulation scenario information storage unit. The same applies in the other embodiments as well.

Also, in this embodiment the simulator parts are of course not limited to the simulator parts illustratively shown above. That is, one of the simulator parts of the two or more different simulator parts shown as an example is a simulator part that performs a simulation of a single myocardial cell, and the other simulator part is a simulator part (finite element module) that calculates the deformation of an organ, but these could well have been other simulator parts as well. The same also applies in the other embodiments as well.

Also, in this embodiment, the format or the structure of the data and the information are not important. The same applies in the other embodiments as well.

In this embodiment, the output unit of the data output part displays the output data received by the output data reception unit, but it is also possible for the output unit to save or to transmit the output data. The same applies in the other embodiments as well.

Further, the processing in this embodiment also can be achieved by software. This software can be distributed by software download, for example. It is also possible for the software to be recorded on and distributed as a recording medium such as a CD-ROM. It should be noted that the same applies in the other embodiments of this specification as well. It should also be noted that the software for achieving the organism simulation device of this embodiment is a program such as the following. That is, the program is an organism simulation program that is provided with two or more different simulator programs, which perform a simulation, that cause a computer to calculate the behavior of an organism's structural elements, that is, the elements making up the organism, such as molecules, cell organelles, cells, tissue, and organs, a data output program that causes a computer to output the simulation results, and a simulation control program that causes a computer to control the transfer of data between the two or more different simulator programs and the data output program. The two or more simulator programs include an input data reception step of receiving data from a user and/or the simulation control program, a calculation step of performing predetermined calculations on the data received in the input data reception step to create output data, and an output data output step of transferring the output data to the simulation control program. The data output program includes an output data reception step of receiving output data from the simulation control program, and an output step of outputting the output data that the output data reception unit has received. The simulation control program includes a data reception step of receiving data from the two or more simulator programs, an input data transfer step of transferring the data received by the data reception unit to the simulator programs based on the simulation scenario information this is stored, and an output data transfer step of transferring the data that are received from the two or more simulator programs to the data output program based on the simulation scenario information.

In the output step of the data output program, it is also possible to display the output data that are received in the output data reception step.

### Embodiment 2

This embodiment describes, among others, an organism simulation device that uses two or more organism element simulator parts and can perform complex organism simulations. In this embodiment, the organism simulation device saves the data of the results of the simulation and uses the data at a later time.

The organism simulation device is provided with two or more different organism element simulator parts, a data output part, and a simulation controller. The two or more different organism element simulator parts receive input and output simulation results. The data output part is for saving the results of the simulation. The simulation controller converts the output of one simulator part into the input for another simulator part and transfers those converted data to the other simulator part, and also transfers the output of the simulator parts as is, or after converting it, to the data output part. The simulator parts simulate behavior on a microscale level, that is, the behavior of each organism structural element, that is, the elements making up the organism, such as molecules, cell organelles, cells, tissue, and organs. The simulation controller allows behavior on a microscale level, that is, the interactions between the organism structural elements, to be simulated. The data output part allows the interactions between the organism's structural elements and the outside environment to be simulated.

The organism simulation device according to this embodiment of the invention is described below using the drawings. FIG. 6 is a block diagram of the organism simulation device of this embodiment. The organism simulation device is provided with at least two different simulator parts (101(1), 101(2), . . . 101(n)), a data output part 802, a simulation controller 103, a simulation scenario information input reception portion 104, a simulation scenario information save portion 105, an output data reception portion 106, an input data retrieve portion 107, and an input data output portion 108. The simulator parts may be collectively referred to by the reference numeral 101.

The data output part 802 is provided with an output data reception unit 1021, an input data obtaining unit 8021, and an output unit 8022.

The input data obtaining unit 8021 obtains data to be input to one or more simulator parts 101. The input data obtaining unit 8021 can directly obtain the input data from the simulator parts 101 or can obtain the input data through the simulation controller 103. It should be noted that in the block diagram in FIG. 8, the configuration of the input data obtaining unit 8021 is such that it obtains input data through the simulation controller 103. The input data obtaining unit 8021 ordinarily can be achieved by an MPU or a memory, for example. The processing procedure of the input data obtaining unit 8021 ordinarily is achieved by software, and that software is recorded on a recording medium such as a ROM. However, it is also possible for the input data obtaining unit 8021 to be achieved by hardware (dedicated circuit).

The output unit 8022 saves the output data received by the output data reception unit 1021 and the input data that are obtained by the input data obtaining unit 8021 as a pair. The recording medium on which the output unit 8022 saves information ideally is a nonvolatile recording medium. It should be noted that this recording medium can be provided in or attached to the outside of the organism simulation device. The output unit 8022 ordinarily can be achieved by an MPU or a memory, for example. The processing procedure of the output unit 8022 ordinarily is achieved by software, and that software is recorded on a recording medium such as a ROM. However, it is also possible for the output unit 8022 to be achieved by hardware (dedicated circuit).

The output data reception portion 106 receives the input of output data. Here, output data are simulation data showing the result of a simulation. Illustrative examples of an input unit for inputting the output data include a number pad, a keyboard, a mouse, or a menu screen. The output data reception portion 106 can be achieved by the device driver of the input unit such as a number pad or a keyboard, or through control software for the menu screen, for example.

The input data retrieve portion 107 retrieves input data that pairs with the output data received by the output data reception portion 106 or with output data that approximate the output data received by the output data reception portion 106. The technology of comparing two output data to determine whether or not they approximate one another is in the public domain, and thus here will not be described in detail. The input data retrieve portion 107 ordinarily can be achieved by an MPU or a memory, for example. The processing procedure of the input data retrieve portion 107 ordinarily is achieved by software, and that software is recorded on a recording medium such as a ROM. However, it is also possible for the input data retrieve portion 107 to be achieved by hardware (dedicated circuit).

The input data output portion 108 outputs the input data that have been retrieved by the input data retrieve portion 107. Output ordinarily means to display on a display, but it conceptually also includes printing on a printer, sound output, and transmitting to an external device. The input data output portion 108 can be regarded as including, or as not including, an output device such as a display or a speaker. The input data output portion 108 can be achieved by driver software for an output device or by driver software for an output device and that output device, for example.

The operation of the organism simulation device is described below. Compared to the simulation device described in Embodiment 1, in this organism simulation device the display of the simulation result has been changed to an operation of saving the output data that are received by the output data reception unit 1021 and the input data that are obtained by the input data obtaining unit 8021 as a pair. Also, when the output data reception portion 106 receives an input of the output data, the input data retrieve portion 107 retrieves input data that pair with the output data received by the output data reception portion 106 or that pair with output data that approximate the output data received by the output data reception portion 106. Next, the input data output portion 108 outputs the input data that have been retrieved by the input data retrieve portion 107. Due to this process, the input data can be retrieved based on the data of an actual patient (output data), and the conditions within the patient's body can be understood.

Next, the specific operation of the organism simulation device of this embodiment is described. The simulation scenario information shown in FIG. 4 have already been stored in the simulation scenario information storage unit 1031. In this state, the input data are input to a simulator part that performs a simulation of a single myocardial cell, and a simulator part that calculates the deformation of the organ. The simulation data described in Embodiment 1 are saved paired with this input data. Then, a database having a plurality of records that pair the input data to the simulator parts and the output data (simulation data), which are the simulation result, is constructed.

Next, the output data reception unit 106 receives an input of actual patient data (output data). The input data retrieve portion 107 then obtains, from the database that is constructed in the above process, the input data that pair with the output data that match or approximate the output data that have been received. The input data output portion 108 then outputs the input data that have been obtained.

Thus, with this embodiment, it is possible to save and use the simulation results. As for the method of using the simulation results, patient data (output data) that can be viewed externally are input, and by obtaining input data to supply to the simulator parts, it is possible to obtain the conditions within a patient's body. Thus, by using the organism simulation device it is possible to learn about a patient's condition in a manner in which patient surgery or tests that place a heavy stress on the patient can be avoided.

It should also be noted that the software for achieving the organism simulation device of this embodiment is a program such as the following. That is, the program is an organism simulation program that is provided with two or more different simulator programs that cause a computer to perform a simulation to calculate the behavior of an organism's structural elements, that is, the elements making up the organism, such as molecules, cell organelles, cells, tissue, and organs, a data output program that causes a computer to output the simulation results, and a simulation control program that causes a computer to control the transfer of data between the two or more different simulator programs and the data output program, wherein the two or more different simulator programs include an input data reception step of receiving data from a user and/or the simulation control program, a calculation step of performing predetermined calculations on the data received in the input data reception step to create output data, and an output data output step of sending the output data to the simulation control program, the data output program includes an output data reception step of receiving output data from the simulation control program, an input data obtaining step of obtaining the data to be input to the simulator parts, and an output step of storing the output data received in the output data reception step and the input data obtained in the input data obtaining step as a pair, and the simulation control program includes a data reception step of receiving data from the two or more simulator parts, an input data transfer step of sending the data received by the data reception step to the simulator programs based on the simulation scenario information this is saved, and an output data transfer step of transferring the data that are received from the two or more simulator programs to the data output program based on the simulation scenario information. The program also causes the computer to execute an output data reception step of receiving the input of output data, an input data retrieve step of retrieving input data that pair with the output data received in the output data reception step or with output data that approximate the output data received in the output data reception step, and an input data output step of outputting the input data retrieved in the input data retrieve step.

### Embodiment 3

In the specific examples, etc., of the embodiments described above, there was an exchange of unidirectional data (i.e. messages) between the simulator part 101 serving as the finite element module (“FEMSimulator”) and the simulator part 101 that performs a simulation of the cell (“CellSimulator”) (see FIG. 4). That is, the change in the cell contraction force that is calculated by the simulator part 101 (“CellSimulator”) is temporarily saved and this saved cell contraction force is converted to an element contraction force and input to the simulator part 101 (“FEMSimulator”). In other words, the simulation scenario information does not reflect the change in muscle length from the simulator part 101 (“FEMSimulator”) in the simulator part 101 (“CellSimulator”). Put differently, the contraction force and muscle length are calculated independently, producing a unidirectional coupled simulation (see FIG. 7). Thus, the precision of the simulation was not sufficient (see FIG. 11, which is discussed later).

In this embodiment, the following specific example is described. That is, first the contraction force calculated by the simulator part 101 (“CellSimulator”) is converted to the element contraction force and input to the simulator part 101 (“FEMSimulator”). Next, the change in shape is converted to the change in half sarcomere length and input to the simulator part 101 (“CellSimulator”). That is, in the specific example discussed in this embodiment, the interaction between the contraction force and the muscle length can be simulated. That is to say, the simulation is a Bi-directional coupled simulation (see FIG. 8). As a result, organism simulation with very high precision is possible (see FIG. 11 discussed later).

The organism simulation device according to this embodiment of the invention is described below. FIG. 1 is a block diagram of the organism simulation device of this embodiment. The organism simulation device is provided with at least two different simulator parts (101(1), 101(2), . . . 101(n)), a data output part 102, a simulation controller 103, a simulation scenario information input reception portion 104, and a simulation scenario information save portion 105. The operation of the organism simulation device of this embodiment is described using the flowcharts of FIG. 2 and FIG. 3.

The specific operation of the organism simulation device in this embodiment is described below. The simulation scenario information shown in FIG. 9 have already been stored in the simulation scenario information storage unit 1031.

First, the simulation scenario information of FIG. 9 is described. The simulation scenario information of FIG. 9 is made of 18 rows of information. The first through sixth rows are the same as those of the simulation scenario information of FIG. 4, and have been described already. The seventh row in FIG. 9 is the same as the ninth row in FIG. 4, and has been described already. The eighth row of FIG. 9 is identical to the tenth row of FIG. 4, other than the parameters.

First, the simulation controller 103 sequentially reads the information of the first row to the eighth row of the simulation scenario information of FIG. 9, and performs the operations discussed in Embodiment 1 based on the information in those rows.

Next, the simulation controller 103 reads and executes the information of the ninth row of the simulation scenario information of FIG. 9. The “[SimulationController->FEMSimulator]getCellLength (length)” of the ninth row in FIG. 9 indicates that a command for obtaining the length of the cell is to be sent from the simulation controller 103 to the finite element module. The simulation controller 103 obtains the length of the cell.

Next, the simulation controller 103 reads and executes the information of the tenth row of the simulation scenario information of FIG. 9. The “[SimulationController->CellSimulator]setCellLength(length)” of the tenth row in FIG. 9 indicates that the simulation controller 103 is to send the length of the cell that it has obtained from the finite element module to the cell simulator. Then, the simulation controller 103 sends the length of the cell to the cell simulator.

Next, the simulation controller 103 reads and executes the information of the eleventh row of the simulation scenario information of FIG. 9. The “[SimulationController->CellSimulator]stepGo(dt)” of the eleventh row in FIG. 9 indicates that the simulation controller 103 is to order the cell simulator to calculate the cell contraction force in a time period dt. Then, the simulation controller 103 orders the cell simulator to calculate for the time period dt, and the cell simulator calculates the cell contraction force over the time period dt.

Next, the simulation controller 103 reads and executes the information of the twelfth row of the simulation scenario information of FIG. 9. The “[SimulationController->CellSimulator]getCellForce(CellForce)” of the twelfth row in FIG. 9 shows that the simulation controller 103 is to obtain the cell contraction force that has been calculated by the cell simulator. Then, the simulation controller 103 obtains the cell contraction force from the cell simulator.

Next, the simulation controller 103 reads and executes the information of the thirteenth row of the simulation scenario information of FIG. 9. The “[SimulationController->FEMSimulator]setCellForce(CellForce)” of the eleventh row in FIG. 9 shows that the simulation controller 103 is to send the cell contraction force that it has obtained to the finite element module. The cell contraction force is then sent to the finite element module.

Next, the simulation controller 103 reads and executes the information of the fourteenth row of the simulation scenario information of FIG. 9. The “[SimulationController->FEMSimulator]stepGo(dt)” of the fourteenth row in FIG. 9 shows that the simulation controller 103 is to order the finite element module to calculate the organ shape (3D shape) over the time period dt. Then, the finite element module calculates the shape of the organ over the time period dt.

Next, the simulation controller 103 reads and executes the information of the fifteenth row of the simulation scenario information of FIG. 9. The “[SimulationController->FEMSimulator]getOrganDeformation(Organ)” of the fifteenth row in FIG. 9 shows that the simulation controller 103 is to obtain, from the finite element module, the organ shape that has been calculated by the finite element module. The simulation controller 103 then obtains the organ shape from the finite element module.

Next, the simulation controller 103 reads and executes the information of the sixteenth row of the simulation scenario information of FIG. 9. The “[SimulationController->Visualizer]setOrganDeformation(Organ)” of the sixteenth row in FIG. 9 shows that the simulation controller 103 is to send the organ shape to the data output part 102. The simulation controller 103 then sends the organ shape to the data output part 102. Next, the data output part 102 receives and outputs the organ shape.

Next, the simulation controller 103 reads and executes the information of the seventeenth row of the simulation scenario information of FIG. 9. The “loop(9,16)” of the seventeenth row of FIG. 9 indicates that the processing of the ninth row to the sixteenth row is to be repeated. Then, the simulation controller 103 then repeats the processing of the ninth row through the sixteenth row until the calculations for one cycle are finished.

Next, the simulation controller 103 reads and executes the information of the eighteenth row of the simulation scenario information of FIG. 9. The “goto(1)” of the eighteenth row of FIG. 9 indicates that the procedure is to be returned to the first row. The simulation controller 103 then returns to the information of the first row of the simulation scenario information. The above processing is then repeated. It should be noted that this processing is ended by turning off the power or interrupting with a processing end command.

As illustrated above, the processing of this specific example is a Bi-directional coupled simulation that simulates the interaction between the contraction force and the muscle length.

The experiment shown in FIG. 10 was performed. In the experiment, a contraction force measurement device was arranged at each end of the cell and the cell length was kept from changing. Then, an experiment in which the contraction force that is produced by changing the length of the cell (half sarcomere length) and is measured, was performed. FIG. 11 graphs the measured values obtained using an actual cell. In the graph of FIG. 11, the horizontal axis is the half sarcomere length (unit: μm) and the vertical axis is the normalized cell contraction force. FIG. 11 shows a graph of the unidirectional coupled simulation of Embodiment 1 and the Bi-directional coupled simulation of this embodiment.

From the graph of FIG. 11 it can be understood that unidirectional coupled simulation leads to a result that is different from an actual cell, whereas Bi-directional coupled simulation leads to results that are substantially identical to those of an actual cell.

Thus, with this embodiment, it is possible to achieve highly precise simulation with ease simply by changing the simulation scenario information, for example. That is, various research is being conducted in the field of medicine, and in many cases the aim is to elucidate the functional elements that make up an organism function. One can say this due to the degree of difficulty of the research. Also, for example, the behavior of various components such as cells influences other behaviors and determines the behavior of the individual organism or organ. The organism simulation device of this embodiment takes into account the characteristics of the medical field, and makes it possible to achieve highly precise simulation in which the simulator parts for simulating the various organism components (e.g. myocardial cells) are structurally separated from the region (simulation controller) that controls the organism components, and in which the incorporation of new simulator parts does not affect other parts. That is, with this embodiment, it is easy to combine simulator parts being scrutinized to permit precise organism simulation that reflects the current state of medicine, and thus facilitates future research and advances in medicine. It is also very easy to expand the simulation functions in conjunction with medical advances.

It should be noted that the Bi-directional coupled simulation discussed in this embodiment obviously also can be adopted in the organism simulation device of Embodiment 2 as well.

Further, in this embodiment, the various processes (various functions) can be achieved by a single device (system) or can be split between a plurality a devices.

That is to say, as an example, in this embodiment it is possible for the simulator parts, the simulator controller, and the data output part, for example, each to be achieved by different devices and for organism simulation to be achieved by sending and receiving messages or data (using a communication function or a broadcast function, for example). The following system is one such organism simulation system. That is, it is an organism simulation system that is provided with two or more different simulator part devices that calculate the behavior of an organism's structural elements, that is, the elements making up the organism, such as molecules, cell organelles, cells, tissue, and organs, a data output part device that outputs the simulation results, and a simulation control device that controls the sending and receiving of data between the two or more different simulator part devices and the data output part device, wherein the two or more simulator part devices include an input data reception unit for receiving data from a user and/or the simulation control device, a calculation unit for performing predetermined calculations on the data received by the input data reception unit to create output data, and an output data output unit for sending the output data to the simulation control device, the data output part device includes an output data reception unit for receiving output data from the simulation control device, and an output unit for outputting the output data received by the output data reception unit, and the simulation control device includes a simulation scenario information storage unit storing simulation scenario information, which is information on the sending and receiving of data between the two or more simulator part devices and the data output part device, and the operation sequence, a data reception unit for receiving data from the two or more simulator part devices, an input data transfer unit for sending the data received by the data reception unit to the simulator part devices based on the simulation scenario information, and an output data transfer unit for sending the data that have been received from the two or more simulator part devices to the data output part device based on the simulation scenario information.

It should be noted that in the above program, the output step of outputting information and the receiving step of receiving information do not include processing that is performed by hardware, such as processing performed by a modem or interface card in the transmission step (which is processing that can only be performed by hardware).

As for the number of computers that execute the above program, there can be a single computer or a plurality of computers. That is, the processes can be performed concentrated in one computer or split among a plurality of computers.

The invention is not limited to the foregoing embodiments and various modifications are possible, and it goes without saying that those modifications also are within the scope of the invention.

### INDUSTRIAL APPLICABILITY

Thus, the organism simulation device of the invention has the effect that various organism functions can be simulated, and it is useful as an organism simulation device for simulating an organism.

### BRIEF DESCRIPTION OF THE DRAWINGS

FIG. 1 is a block diagram of the organism simulation device of Embodiment 1.

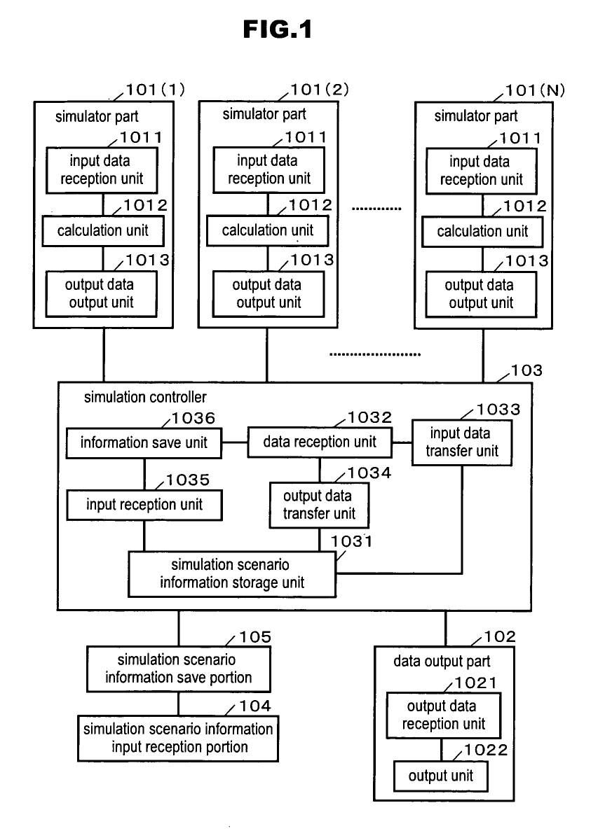

FIG. 2 is a flowchart describing the operation of that organism simulation device.

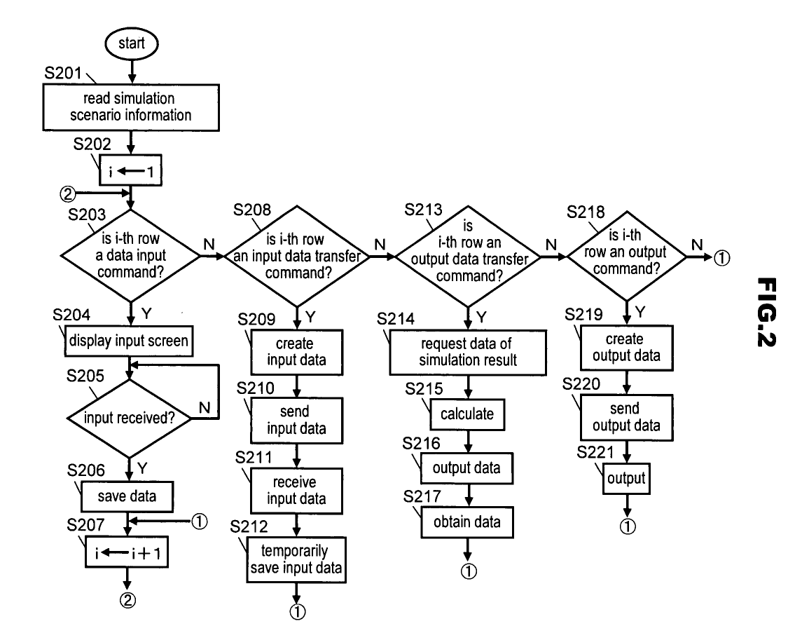

FIG. 3 is a flowchart describing the operation of the simulation controller of the same.

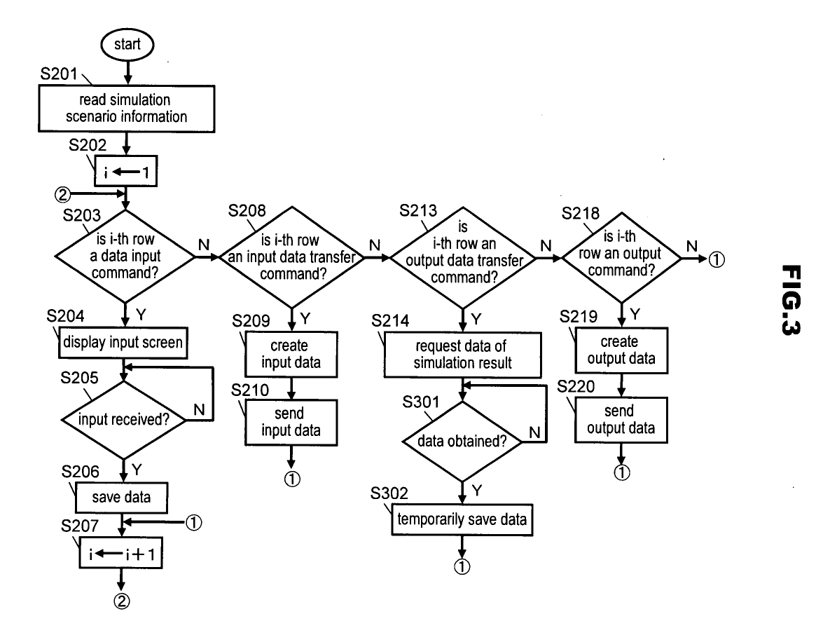

FIG. 4 is a diagram showing an example of the simulation scenario information of the same.

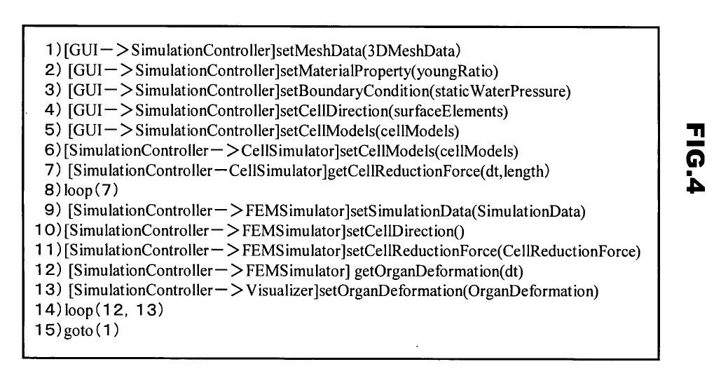

FIG. 5 is a diagram showing an example of the display of a simulation of the same.

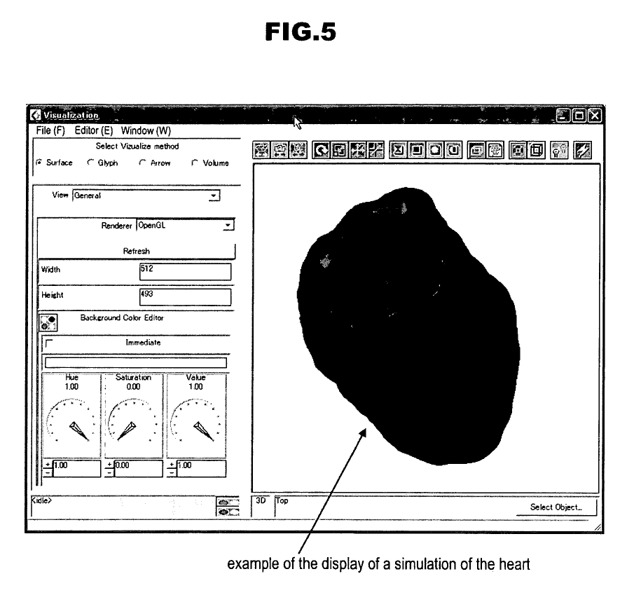

FIG. 6 is a block diagram of the organism simulation device according to Embodiment 2.

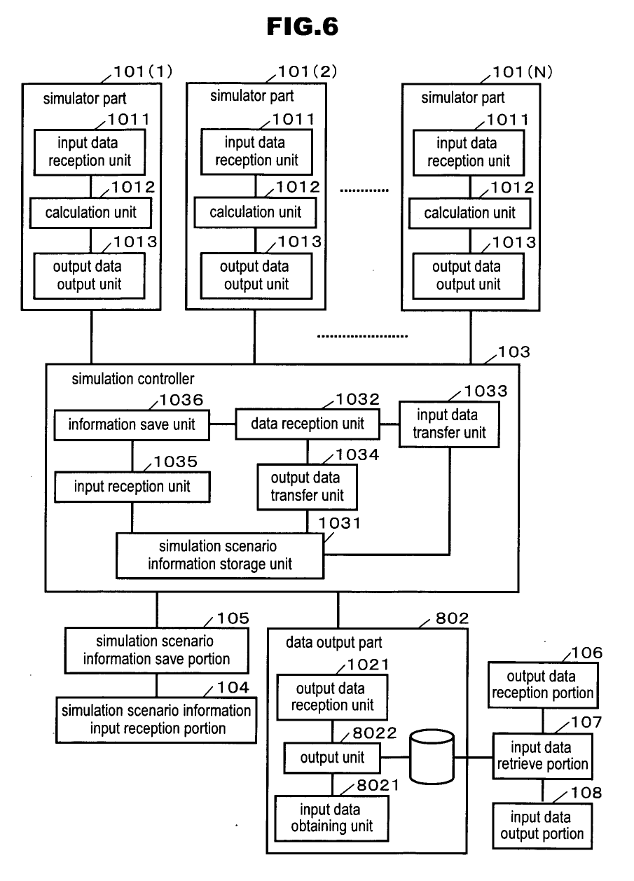

FIG. 7 is a conceptual diagram of unidirectional coupling simulation in Embodiment 3.

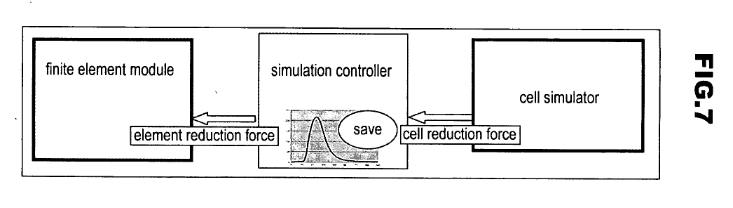

FIG. 8 is a conceptual diagram of Bi-directional coupling simulation in the same.

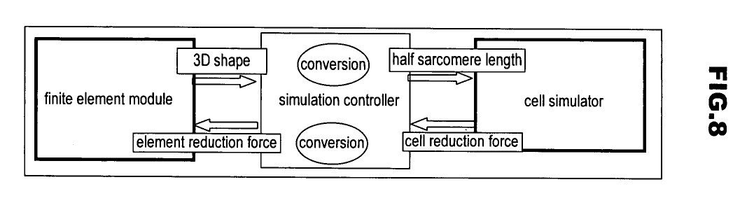

FIG. 9 is a diagram showing an example of the simulation scenario information of the same.

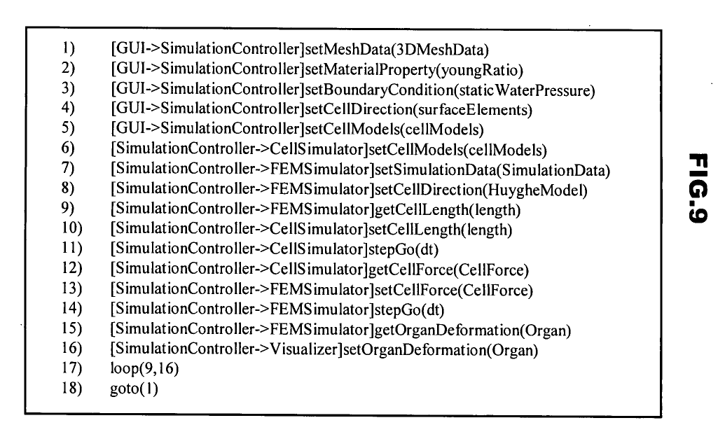

FIG. 10 shows an overview of the experiment of the same.

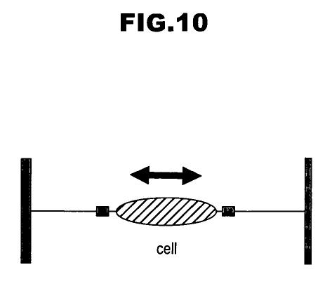

FIG. 11 shows a graph of the experiment results.

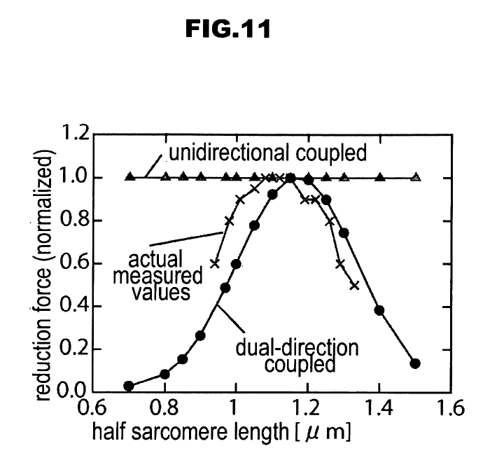

1. An organism simulation device comprising:
two or more different simulator parts that calculate the behavior of an organism's structural elements, which are the elements making up the organism, such as molecules, cell organelles, cells, tissue, and organs;
a data output part that outputs simulation results; and
a simulation controller that controls a transfer of data between the two or more different simulator parts and the data output part;
wherein the two or more simulator parts comprise:
an input data reception unit for receiving data from a user and/or the simulation controller;
a calculation unit for performing predetermined calculations on the data received by the input data reception unit to create output data; and
an output data output unit for transferring the output data to the simulation controller;
wherein the data output part comprises:
an output data reception unit for receiving output data from the simulation controller; and
an output unit for outputting the output data received by the output data reception unit; and
wherein the simulation controller comprises:
a simulation scenario information storage unit storing simulation scenario information, which is information on the flow of data between the two or more simulator parts and the data output part, and the operation sequence;
a data reception unit for receiving data from the two or more simulator parts;
an input data transfer unit for transferring the data received by the data reception unit to the simulator parts based on the simulation scenario information; and
an output data transfer unit for transferring the data that have been received from the two or more simulator parts to the data output part based on the simulation scenario information.

2. The organism simulation device according to claim 1,
wherein the output unit of the data output part displays the output data received by the output data reception unit.

3. The organism simulation device according to claim 1,
wherein the data output part further comprises:
an input data obtaining unit for obtaining input data to be input to the simulator parts;
wherein the output unit saves the output data received by the output data reception unit and the input data obtained by the input data obtaining unit as a pair.

4. The organism simulation device according to claim 3, further comprising:
an output data reception portion that receives an input of output data;
an input data retrieve portion that retrieves input data that pair with the output data that are received by the output data reception portion, or with output data that approximate the output data that are received by the output data reception portion; and
an input data output portion that outputs the input data that have been retrieved by the input data retrieve portion.

5. The organism simulation device according to claim 1, further comprising:
a simulation scenario information input reception portion that receives an input of the simulation scenario information; and
a simulation scenario information save portion that saves the simulation scenario information that is received by the simulation scenario information input reception portion on the simulation scenario information storage unit.

6. The organism simulation device according to claim 1,
wherein one simulator part of the two or more different simulator parts is a simulator part that performs a simulation of a single myocardial cell, and
another simulator part is a simulator part that calculates a deformation of an organ.

7. The organism simulation device according to claim 1,
wherein the simulation scenario information includes send/receive destination information that indicates where information is to be transmitted to and received from, and command information that indicates a command.

8. An organism simulation program comprising:
two or more different simulator programs that cause a simulation to be performed, and that cause the computer to calculate the behavior of an organism's structural elements, which are the elements making up the organism, such as molecules, cell organelles, cells, tissue, and organs;
a data output program that causes a computer to output simulation results; and
a simulation control program that causes a computer to control a transfer of data between the two or more different simulator programs and the data output program;
wherein the two or more simulator programs comprise:
an input data reception step of receiving data from a user and/or the simulation control program;
a calculation step of performing predetermined calculations on the data received in the input data reception step to create output data; and
an output data output step of transferring the output data to the simulation control program;
wherein the data output program comprises:
an output data reception step of receiving output data from the simulation control program; and
an output step of outputting the output data received by the output data reception step; and
wherein the simulation control program comprises:
a data reception step of receiving data from the two or more simulator programs;
an input data transfer step of transferring the data received by the data reception step to the simulator programs based on simulation scenario information that is stored; and
an output data transfer step of transferring the data that have been received from the two or more simulator programs to the data output program based on the simulation scenario information.

9. The program according to claim 8,
wherein the output step of the data output program displays the output data received in the output data reception step.

10. The program according to claim 8,
wherein the data output program further causes a computer to execute an input data obtaining step of obtaining input data to be input to the simulator programs;
wherein in the output step, the output data received in the output data reception step and the input data obtained in the input data obtaining step are saved as a pair.

11. The program according to claim 10, further causing a computer to execute:
an output data reception step of receiving an input of output data;
an input data retrieve step of retrieving input data that pair with the output data that are received in the output data reception step, or with output data that approximate the output data that are received in the output data reception step; and
an input data output step of outputting the input data that have been retrieved in the input data retrieve step.

12. The program according to claim 8, further causing a computer to execute:
a simulation scenario information input reception step of receiving an input of the simulation scenario information; and
a simulation scenario information save step of saving the simulation scenario information that is received in the simulation scenario information input reception step.

13. The program according to claim 8,
wherein one simulator program of the two or more different simulator programs is a simulator program that performs a simulation of a single myocardial cell, and
another simulator program is a simulator program that calculates a deformation of an organ.

14. The program according to claim 8,
wherein the simulation scenario information includes send/receive destination information that indicates where information is to be transmitted to and received from, and command information that indicates a command.

15. An organism simulation system comprising:
two or more different simulator part devices that calculate the behavior of an organism's structural elements, which are the elements making up the organism, such as molecules, cell organelles, cells, tissue, and organs;
a data output part device that outputs simulation results; and
a simulation control device that controls a transfer of data between the two or more different simulator part devices and the data output part device;
wherein the two or more simulator part devices comprise:
an input data reception unit for receiving data from a user and/or the simulation control device;
a calculation unit for performing predetermined calculations on the data received by the input data reception unit to create output data; and
an output data output unit for sending the output data to the simulation control device;
wherein the data output part device comprises:
an output data reception unit for receiving output data from the simulation control device; and
an output unit for outputting the output data received by the output data reception unit; and
wherein the simulation control device comprises:
a simulation scenario information storage unit storing simulation scenario information, which is information on the sending and receiving of data between the two or more simulator part devices and the data output part device, and the operation sequence;
a data reception unit for receiving data from the two or more simulator part devices;
an input data transfer unit for sending the data received by the data reception unit to the simulator part devices based on the simulation scenario information; and
an output data transfer unit for sending the data that have been received from the two or more simulator part devices to the data output part device based on the simulation scenario information.
